(19) United States
(12) Patent Application Publication
(10) Pub. No.: US 2014/0340207 A1
(43) Pub. Date: Nov. 20, 2014

(54) Vibrating Alert Device for Radar and Lidar Warning Receiver

(71) Applicant: Charles William Priest, III, Jacksonville, FL (US)

(72) Inventor: Charles William Priest, III, Jacksonville, FL (US)

(21) Appl. No.: 13/920,455

(22) Filed: Jun. 18, 2013

Related U.S. Application Data
(60) Provisional application No. 61/822,962, filed on May 14, 2013.

(51) Int. Cl. G08B 6/00

(52) U.S. Cl. CPC G08B 6/00
USPC 340/407.1

(57) ABSTRACT

A vibrating alert device for a radar and lidar warning receiver. The invention is to be powered by the automobile electrical system, in the case of the wired version, and by the automobile electrical system and device battery or mobile power supply for the wireless version. The invention provides a vibrating alert to an off the shelf radar and radar/lidar warning receiver which does not otherwise have one.

### CROSS-REFERENCE TO RELATED APPLICATION

This application claims the benefit of U.S. Provisional Application No. 61/822,962, filed May 14, 2013.

### BACKGROUND

1. Field of the Invention

This invention relates to the field of automobile radar and lidar detection. More specifically, this invention comprises a wearable, vibrating alert device that optionally works in conjunction or in place of the warning receiver's audible and visual alerts.

2. Description of the Related Art

There are many known forms of vibrating alerts used in devices ranging from the field of cellular telephones and pagers, to video game controllers that provide a vibrating feedback to the user. In every case, this provides an enhanced communication to the user by way of the sense of touch.

Radar warning receivers alert the automobile driver to the presence of radar and lidar, which are commonly used by police officers to determine if a speed infraction has been committed by the driver. These receivers give an audible and visual warning of presence and intensity of the radar or lidar beam, allowing the automobile driver the chance to slow down to the speed limit before being ticketed with an infraction. Many of these receivers also feature a special power supply plug that plugs into the vehicle's accessory port or cigarette lighter port. This special power supply also may incorporate an LED light that emits light while the receiver is alerting, providing a second location for a visual alert.

A short-coming of radar and lidar warning technology has been that the audible alert cannot be heard over the sound of rushing wind or a car stereo with the volume turned up. Persons who are deaf will also not hear the audible alert. The visual alert is also often overlooked due to dim displays during the daylight, or the driver paying needed attention to activities on the road ahead.

Production radar and lidar warning receivers have not incorporated this feature in any way. The present invention seeks to provide such a vibrating alert to be used with a radar warning receiver for the purpose of better communication with the driver.

### SUMMARY

The present invention comprises a wearable, vibrating alert device for use with a radar/lidar detector. The invention is intended to be an accessory to current off-the-shelf radar and radar/lidar warning receivers. The invention is configured to accept an output signal from the radar/lidar warning receiver that coincides with the receiver's own alerts. Upon receiving the alert signal from the radar/lidar receiver, the invention begins to vibrate while matching intensity of the vibration with the intensity of the audible and visual alert provided by the radar/lidar warning receiver.

In one embodiment, the invention is attached to a strap or clip and worn on the arm, leg or other portion of the body. It can also be clipped to a belt like a pager. A wire connects the invention to the warning receiver's visual alerting power supply cord or smart cord, intercepting the alert signal and providing operational power to the invention. Inside the invention is a vibration motor which is activated to follow the intensity and pattern of the alert coming from the radar/lidar warning receiver.

In a second embodiment, the invention is configured for wireless operation so that the wearer is unencumbered by a signal/power cord. The vibrating portion of the invention is attached to a strap or clip and worn on the arm, leg or other portion of the body. A wire connects a radio transmitter to the warning receiver's visual alerting power supply cord or smart cord, intercepting the alert signal and providing operational power to the radio transmitter. Inside the vibrating portion of the invention is a vibration motor, radio receiver and battery power supply. The radio receiver activates the vibration motor when it receives a signal from the radio transmitter. The vibration motor then follows the intensity and pattern of the alert coming from the radar/lidar warning receiver.

### BRIEF DESCRIPTION OF THE DRAWINGS

FIG. 1 is a perspective view of the invention in an assembled state.

FIG. 2 is a view of the vibrating housing in a partially disassembled state.

FIG. 3 is a perspective view of the second embodiment of the invention in an assembled state.

FIG. 4 is a diagram of the circuit used in the signal processing module.

### DETAILED DESCRIPTION

The figures referred to in the following description are not intended to restrict the form of the invention, but instead, are provided as examples to illustrate how the invention works.

Anyone skilled in the art and with sufficient expertise will realize similar versions of the invention that would yield the same results.

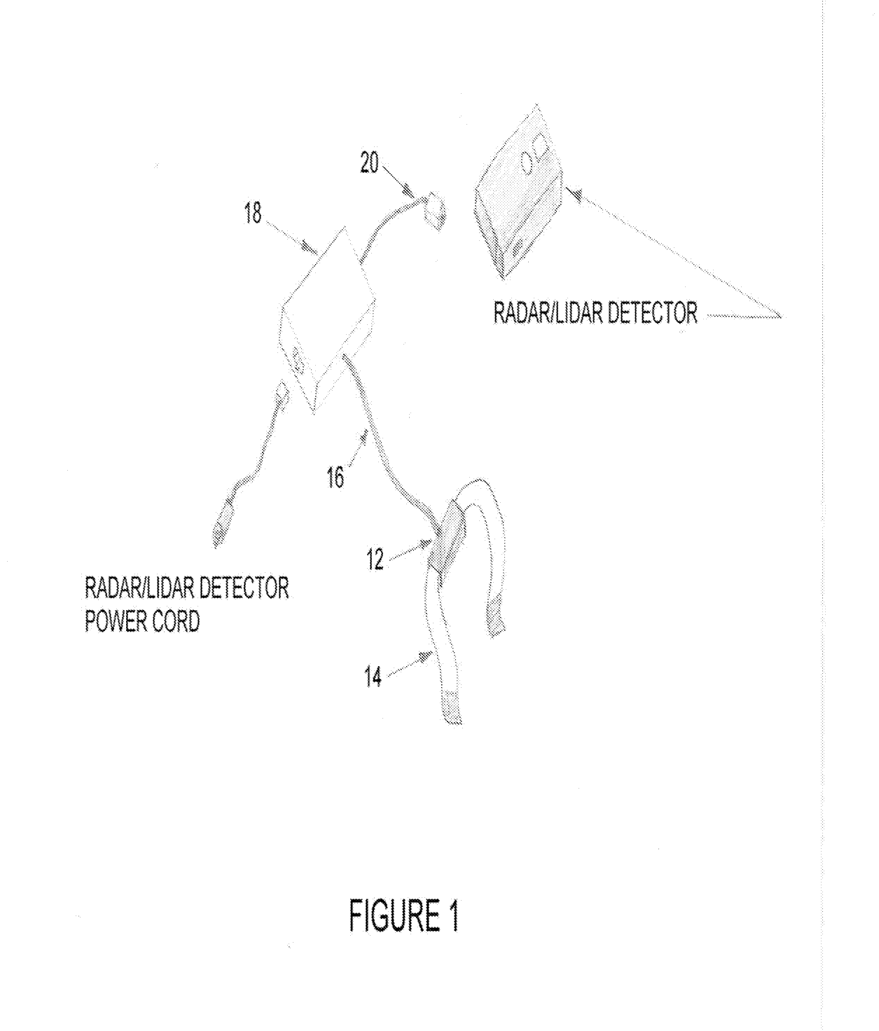

FIG. 1. shows a perspective view of the invention in an assembled state. Vibration alert system includes housing 12, body or appendage strap 14 and power and signal cord 16. The housing is attached to the strap 14, which allows the housing to be worn. The power and signal cord 16, attaches to the signal processing module 18 and then, to components inside the housing 12. The signal processing module plugs into the radar/lidar warning receiver power supply port using wire 20. It also intercepts the warning signal coming from the radar/lidar warning receiver. The radar/lidar warning receiver power cord plugs into the signal processing module in order for both the radar/lidar warning receiver and the invention to receive power from the vehicle.

The signal processing module uses the vehicle power, supplied from the radar/lidar warning receiver power supply cord, to amplify the warning signal that is also provided by the radar/lidar warning receiver through the same power supply cord. The output from the signal processing module is a stronger copy of the signal supplied to it that is sufficient to operate the vibrating motor contained within the housing 12.

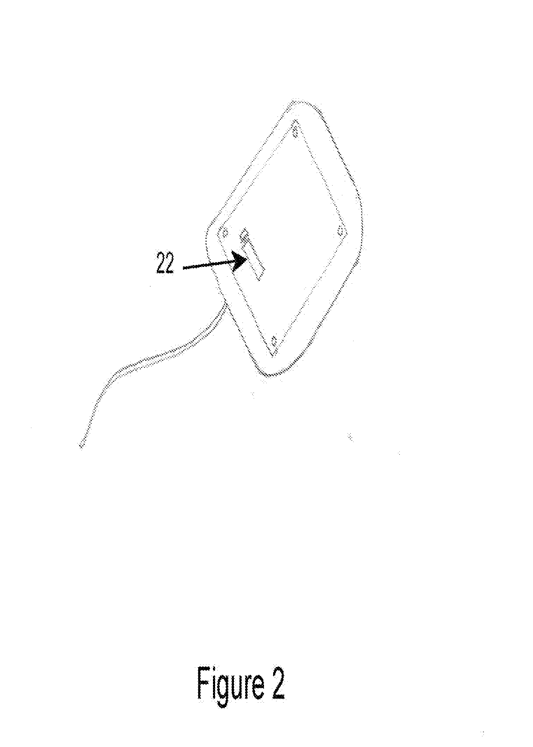

FIG. 2 shows a partially disassembled view of the housing, FIG. 1, item 12. The housing top is removed. Within the housing is a vibrating motor 22.

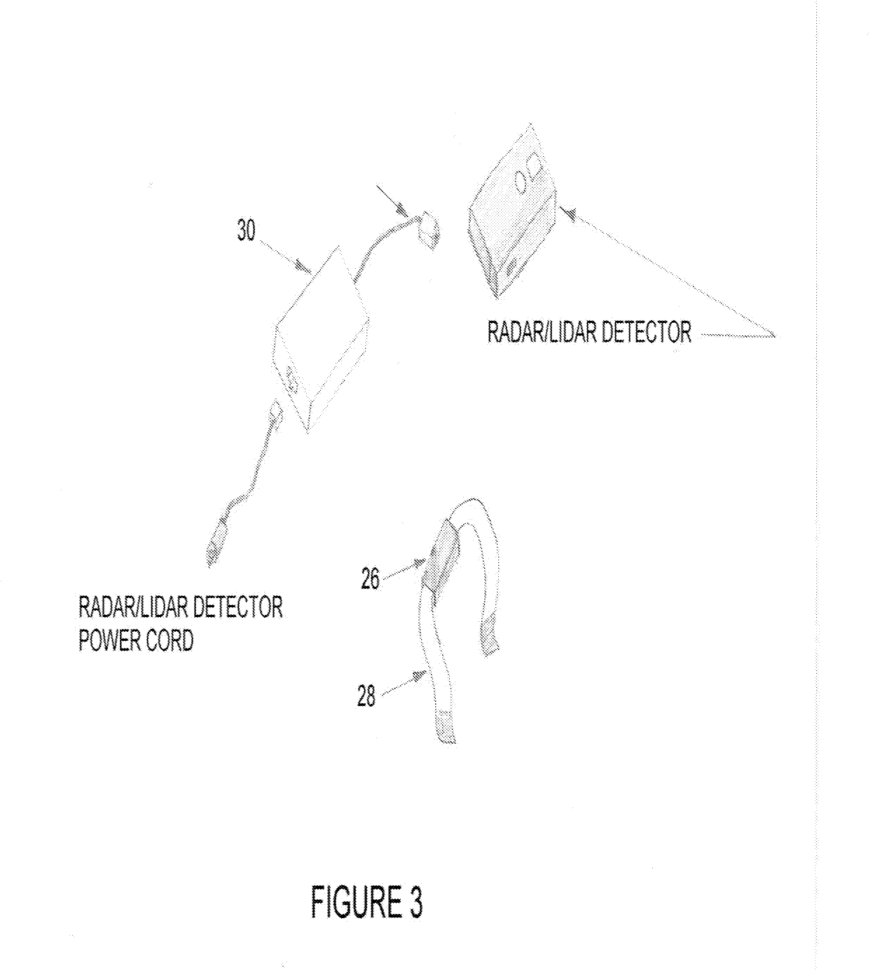

A second embodiment of the invention allows for wireless operation. FIG. 3 shows this embodiment in an assembled state. Vibration alert system includes vibrating housing 26, body or appendage strap 28 and signal processing module 30. The housing is attached to the strap 28, which allows the housing to be worn. The signal processing module 30, plugs into the radar/lidar warning receiver power supply port. The special power supply cord supplied with the radar/lidar warning receiver is plugged into the signal processing in order for both the radar/lidar warning receiver and the signal processing module to receive power from the vehicle.

When the radar/lidar warning receiver detects a radar signal, the audio and visual alerts will trigger and a warning signal will be sent through the special power supply cord. The signal processing module receives the signal, then, activates a wireless transmitter to send a wireless signal that matches the pattern of the signal received from the radar/lidar warning receiver. A radio receiver in the vibrating housing 26, receives the radio signal from the signal processing module 30 and sends a corresponding electrical signal to an amplifier within the vibrating housing, which amplifies the signal and sends it to the vibrating motor, also within the vibrating housing. The vibrations from the vibrating motor are felt by the automobile driver, thereby alerting him to the radar/lidar threat. The vibrating housing is powered by battery or other mobile power source.

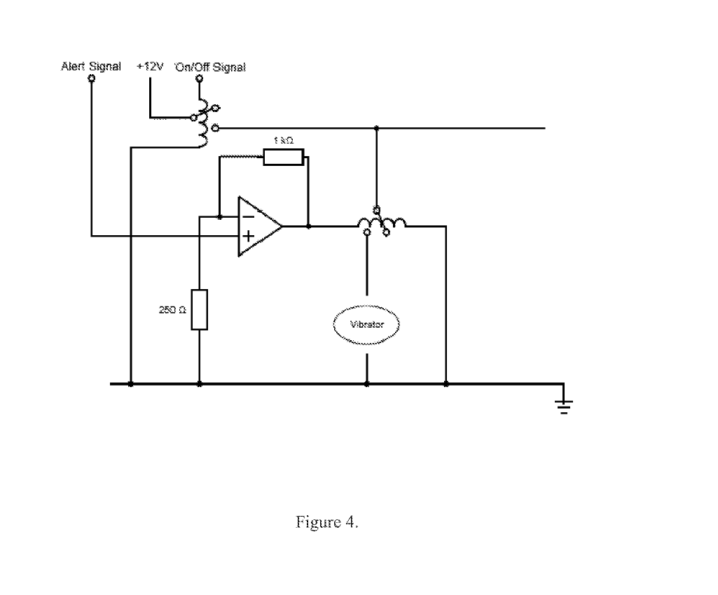

FIG. 4 is an example of the circuit used in the signal processing module. Since the alert signal provided by many radar and radar/lidar warning receivers is too weak to power the vibrating motor, an amplifier is used for these to amplify the voltage and or current in order to activate a relay. The activated relay then transmits greater power from a source to the vibrating motor.

1. An external vibrating alert device for a radar and lidar warning receiver.

2. A vibrating alert device as claimed in item 1 that receives an alert signal from an existing radar and lidar warning receiver and then sends a signal to activate a wearable vibrating alert.

3. A device as claimed in item 2, utilizing a wireless means to transmit an activating signal to a wearable vibrating module, wherein said vibrating module vibrates upon receipt of the wireless signal.

4. A device as claimed in item 2, utilizing a wired means to transmit an activating signal to a wearable vibrating module, wherein said vibrating module vibrates upon receipt of transmitted signal.
